(19) United States
(12) Patent Application Publication
(10) Pub. No.: US 2023/0371552 A1
(43) Pub. Date: Nov. 23, 2023

(54) Pet Food Compositions

(71) Applicant: Hill's Pet Nutrition, Inc., Topeka, KS (US)

(72) Inventor: Matthew JACKSON, Topeka, KS (US)

(73) Assignee: Hill's Pet Nutrition, Inc., Topeka, KS (US)

(21) Appl. No.: 18/321,211

(22) Filed: May 22, 2023

Related U.S. Application Data
(60) Provisional application No. 63/344,985, filed on May 23, 2022.
(60) Provisional application No. 63/352,461, filed on Jun. 15, 2022.

(51) Int. Cl. A23K 50/40; A23K 20/147; A23K 20/174; A23K 20/158; A23K 10/30

(52) U.S. Cl. CPC A23K 50/40; A23K 20/147; A23K 20/174; A23K 20/158; A23K 10/30

(57) ABSTRACT

Pet food compositions as well as methods for alleviating canines suffering from chronic gastroenteritis are disclosed herein. The pet food composition may comprise a fat; from about 15 to about 50 wt. % of protein comprising one or more amino acids, wherein the one or more amino acid comprise glycine, proline, or a combination of two or more thereof; from about 3.5 to about 35 wt. % of a fiber, the fiber comprising: (i) from about 3 to about 30 wt. % of insoluble fiber, (ii) from about 0.5 to about 5 wt. % of soluble fiber, optionally, a carbohydrate, wherein all weight percentages are based on the total weight of the pet food composition on a dry matter basis.

### CROSS-REFERENCE TO RELATED PATENT APPLICATIONS

This application claims priority to U.S. Appl. No. 63/344,985, entitled PET FOOD COMPOSITIONS, filed on May 23, 2022, and U.S. Appl. No. 63/352,461, entitled PET FOOD COMPOSITIONS, filed on Jun. 15, 2022, the contents of each are incorporated herein by reference in their entireties for all purposes.

### BACKGROUND

Animals, particularly companion pet animals (e.g., dogs and cats), suffer from a wide variety of health issues as they age. Previous attempts to address these issues focused on treating being over-weight, or in extreme cases being obese. Specifically, food compositions were specifically tailored to reduce caloric intake or affect metabolism solely to reduce the weight of the animal. Separate from controlling the diet of an animal, these animals also suffer from separate age-related gastrointestinal health issues.

As an additional difficulty for producing pet food compositions that may be tailored to modify caloric intake and/or address gastrointestinal health issues, determining the appropriate level of dietary protein for the respective animal is challenging. Increasing the dietary protein levels in an animal's food may help prevent sarcopenia through preservation of lean mass, and to induce food satiety that will bolster compliance with weight management diets, but may lead to an increased amount of dietary protein bypassing digestion to be putrefied by resident commensal gut bacteria. Microbial protein putrefaction products can be detrimental to the progression of renal disease in renal compromised pets.

There is an ongoing desire for improved pet food compositions that can provide health benefits to domestic pets.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

In accordance with an aspect of the invention, provided is a pet food composition comprising a fat; from about 15 to about 50 wt. % of protein comprising one or more amino acids, wherein the one or more amino acid comprises glycine, proline, or a combination of two or more thereof; from about 3.5 to about 35 wt. % of a fiber, the fiber comprising: (i) from about 3 to about 30 wt. % of insoluble fiber, (ii) from about 0.5 to about 5 wt. % of soluble fiber, optionally, a carbohydrate, wherein all weight percentages are based on the total weight of the pet food composition on a dry matter basis.

The fiber component of the pet food composition may comprise an acid detergent fiber and a neutral detergent fiber, wherein a total amount of the acid detergent fiber and the neutral detergent fiber is from about 6 to about 20 wt. %, based on the total weight of the pet food composition on a dry matter basis. In some embodiments, the pet food composition has a weight ratio of the acid detergent fiber to the neutral detergent fiber of from about 2:1 to about 1:2. Additionally or alternatively, the pet food composition the pet food composition may have a weight ratio of insoluble fiber to soluble fiber from about 20:1 to about 8:1.

Preferably, the pet food composition includes one or more vitamins, such as one or more vitamin B selected from thiamin, riboflavin, niacin, pantothenic acid, pyridoxine, biotin, folic acid, cobalamin and a combination of two or more thereof. In some instances, the pet food composition has at least one of Thiamin in an amount of from about 8 to about 20 mg/100 g, Pyridoxine in an amount of from about 1 to about 4 mg/100 g, Cobalamin in an amount of from about 10 to about 40 ug/100 g, and Folic Acid in an amount of from about 100 to about 400 ug/100 g. The pet food composition may be formulated to have a weight ratio of folic acid to cobalamin of from about 1:1 to about 50:1, preferably about 1:1 to about 40:1, preferably about 3:1 to about 40:1, or preferably about 5:1 to about 40:1. Additionally or alternatively, the pet food composition may have a weight ratio of thiamin to pyridoxine of from about 1:1 to about 30:1, preferably about 2:1 to about 30:1, or preferably about 2:1 to about 20:1.

In some embodiments, the pet food composition includes at least one medium chain triglyceride having an aliphatic carbon chain comprising from 6 to 10 carbons. For instance, the at least one medium chain triglyceride may be selected from caprylate, caprate, or a combination thereof. The pet food composition may include omega-3 fatty acid, such as those selected from linolenic acid, stearidonic acid, eicosatetraenoic acid, eicosapentaenoic acid, docosapentaenoic acid, docosahexaenoic acid, and a combination of two or more thereof. In at least one embodiment, the pet food composition comprises at least one omega-3 fatty acid selected from linolenic acid, stearidonic acid, eicosatetraenoic acid, eicosapentaenoic acid, docosapentaenoic acid, docosahexaenoic acid, and a combination of two or more thereof, and comprises at least one medium chain triglyceride having an aliphatic carbon chain comprising from 6 to 10 carbons. Additionally or alternatively, the pet food composition may include betaine, optionally, in an amount of from 0.01 to about 5 wt. %, based on the total weight of the pet food composition on a dry matter basis.

According to another aspect of the invention, a pet food is provided comprising from about 8 to about 50 wt. % of a fat; from about 15 to about 50 wt. % of a protein comprising two or more amino acids, wherein the two or more amino acids comprise glycine and proline; from about 3.5 to about 35 wt. % of a fiber, the fiber comprising: (i) from about 3 to about 30 wt. % of insoluble fiber, (ii) from about 0.5 to about 5 wt. % of soluble fiber, optionally, a carbohydrate in an amount up to 65 wt. %; two or more triglycerides; and two or more vitamin B, wherein all weight percentages are based on the total weight of the pet food composition on a dry matter basis.

In accordance with yet another aspect of the invention, provided is a method for alleviating canines suffering from chronic gastroenteritis, the method comprising: feeding a canine a pet food composition disclosed herein. The method may include providing and/or feeding the canine a pet food composition disclosed herein. In some instances, the method may include providing and/or feeding the canine the pet food compositions for 1 or more days, preferably 5 or more days, preferably 7 or more days, preferably 10 or more days, preferably 14 or more days, preferably 30 or more days, or preferably 42 or more days.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other compositions and methods. Before explaining the disclosed embodiments of the present invention in detail, it is to be understood that the invention is not necessarily limited in its application to the details of any particular embodiment disclosed. The terminology used herein is for the purpose of description and not of limitation.

As used herein and in the appended claims, the singular forms “a”, “an”, and “the” include plural references unless the context dictates otherwise. The singular form of any class of the ingredients refers not only to one ingredient within that class, but also to a mixture of those ingredients. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range. Thus, a range from 1-5, includes specifically 1, 2, 3, 4 and 5, as well as subranges such as 2-5, 3-5, 2-3, 2-4, 1-4, etc. The term “about” when referring to a number means any number within a range of 10% of the number. For example, the phrase “about 2 wt. %” refers to a number between and including 1.8 wt. % and 2.2 wt. %.

All references cited herein are hereby incorporated by reference in their entireties. In the event of a conflict in a definition in the present disclosure and that of a cited reference, the present disclosure controls.

The abbreviations and symbols as used herein, unless indicated otherwise, take their ordinary meaning. The abbreviation “wt. %” means percent by weight with respect to the pet food composition. The symbol “°” refers to a degree, such as a temperature degree or a degree of an angle. The symbols “h”, “min”, “mL”, “nm”, “μm” means hour, minute, milliliter, nanometer, and micrometer, respectively. The abbreviation “UV-VIS” referring to a spectrometer or spectroscopy, means Ultraviolet-Visible. The abbreviation “rpm” means revolutions per minute.

Any member in a list of species that are used to exemplify or define a genus, may be mutually different from, or overlapping with, or a subset of, or equivalent to, or nearly the same as, or identical to, any other member of the list of species. Further, unless explicitly stated, such as when reciting a Markush group, the list of species that define or exemplify the genus is open, and it is given that other species may exist that define or exemplify the genus just as well as, or better than, any other species listed.

All components and elements positively set forth in this disclosure can be negatively excluded from the claims. In other words, the pet food compositions of the instant disclosure can be free or essentially free of all components and elements positively recited throughout the instant disclosure. In some instances, the pet food compositions of the present disclosure may be substantially free of non-incidental amounts of the ingredient(s) or compound(s) described herein. A non-incidental amount of an ingredient or compound is the amount of that ingredient or compound that is added into the pet food composition by itself. For example, a pet food composition may be substantially free of a non-incidental amount of an ingredient or compound, although such ingredient(s) or compound(s) may be present as part of a raw material that is included as a blend of two or more compounds. Substantially free, unless other defined or described herein, typically refers to an ingredient or compound in an amount of about 2 wt. % or less, about 1.5 wt. % or less, about 1 wt. % or less, about 0.5 wt. % or less, about 0.1 wt. % or less, about 0.05 wt. % or less, or about 0.01 wt. % or less, based on the total weight of the pet food composition on a dry matter basis.

Some of the various categories of components identified may overlap. In such cases where overlap may exist and the pet food composition includes both components (or the composition includes more than two components that overlap), an overlapping compound does not represent more than one component. For example, certain components or ingredients may be characterized as both an ancient grain and an amaranth. If a particular pet food care composition recites both an ancient grain and an amaranth, a compound that may be characterized as both an ancient and an amaranth will serve only as either an ancient grain or an amaranth—not both.

As used herein, the term “pet” could be used interchangeably with “companion animal” and refers to an animal of any species kept by a caregiver as a pet or any animal of a variety of species that have been widely domesticated as pets, including canines (Canis familiaris) and felines (Felis domesticus). Thus, a pet may include but is not limited to, working dogs, pet dogs, cats kept for rodent control (i.e. farm cats), pet cats, ferrets, birds, reptiles, rabbits, and fish.

To the extent that food and food ingredient contain water/moisture, the dry matter represents everything in the sample other than water including, for example, protein, fiber, fat, carbohydrates, minerals, etc. Dry matter weight is the total weight minus the weight of any water. The skilled artisan would readily recognize and understand nutritional amounts and percentages expressed as dry matter amounts, dry matter weights and dry matter percentages.

Dry matter intake per day is calculated as the total nutritional intake per day excluding all water. For example, an amount of an ingredient equal to a specific percent of daily nutritional intake refers to the amount of that ingredient in dry matter form (i.e., excluding all water) relative to the total amount of dry matter consumed (also excluding all water) in a day.

“Daily nutritional intake” and “total nutritional intake per day” refer to dry matter intake per day. That is, water weight is not included in calculating the amount of nutrition consumed per day. To calculate percent of an ingredient of total daily intake on a dry matter basis, water is removed from the total intake to give total daily dry matter intake and the percentage of the ingredient is based on amount of ingredient present as dry matter.

As used herein, an “ingredient” refers to any component of a pet food composition. The term “nutrient” refers to a substance that provides nourishment and thus has a nutrient value. In some cases, an ingredient may comprise more than one “nutrient,” for example, a composition may comprise corn comprising important nutrients including both protein and carbohydrate.

Aspects of the invention are directed to pet food compositions and methods for improving the health of pets. In some aspects, the pet food compositions contain higher amounts of protein, while avoiding heightened levels of gut microbial protein putrefaction typical with conventional pet food compositions containing such levels of dietary protein. For instance, certain embodiments of the pet food compositions contain higher than typical amounts of protein while simultaneously reducing protein putrefaction and gut microbial metabolites, and/or improving the gut barrier of the pet. The pet food compositions may contain, e.g., about 83% more protein than minimum required by the AAFCO regulatory body and about 40% more protein than conventional pet food compositions for canines, while decreasing putrefaction of individual amino acids by gut microbes (see Tables 3-7 and 9). Additionally, the reduction in protein putrefaction and gut microbial metabolites achieved by certain embodiments of the pet food composition in view of the higher amounts of protein was unexpected as it is conventionally expected that increasing the amount of protein yields increased amounts of gut microbial protein putrefaction, which produces detrimental uremic solutes. Moreover, the reduction in protein putrefaction achieved by certain embodiments of the pet food composition were particularly surprising as recent studies have warned that using large amounts of highly digestible protein can increase the negative effects in canine, and that the use of less digestible protein at similar concentrations may still elicit similar negative effects.

The inventors further discovered that pet food compositions having specific combinations of protein in certain ratios in conjunction with specific combinations in fiber yielded significant benefits to pets consuming such pet food compositions, including, e.g., improved health of the pet's gut. Additionally, certain embodiments include specific combinations of triglycerides, fatty acids, vitamins, and/or other additives to provide enhanced health benefits. For instance, certain pet food compositions included large amounts of betaine, which surprisingly did not undermine the other benefits (including, e.g., significant reduction of protein putrefaction and gut microbial metabolite achieved by the pet food composition) of the invention. In some embodiments, the pet food composition yield significant reductions in gut microbial metabolites that may be detrimental to pets while simultaneously reducing sarcopenia and obesity and provided larger amounts of protein to the pet.

In one aspect of the invention, provided is a pet food composition comprising a fat; from about 15 to about 50 wt. % of protein comprising one or more amino acids, wherein the one or more amino acid comprises glycine, proline, or a combination of two or more thereof; from about 3.5 to about 35 wt. % of a fiber, the fiber comprising: (i) from about 3 to about 30 wt. % of insoluble fiber, (ii) from about 0.5 to about 5 wt. % of soluble fiber, optionally, a carbohydrate, wherein all weight percentages are based on the total weight of the pet food composition on a dry matter basis.

According to another aspect of the invention, a pet food is provided comprising from about 8 to about 50 wt. % of a fat; from about 15 to about 50 wt. % of a protein comprising two or more amino acids, wherein the two or more amino acids comprise glycine and proline; from about 3.5 to about 35 wt. % of a fiber, the fiber comprising: (i) from about 3 to about 30 wt. % of insoluble fiber, (ii) from about 0.5 to about 5 wt. % of soluble fiber, optionally, a carbohydrate in an amount up to 65 wt. %; two or more triglycerides; and two or more Vitamin B, wherein all weight percentages are based on the total weight of the pet food composition on a dry matter basis.

The pet food compositions may include a reduced amount of tryptophan, phenylalanine, and/or tyrosine. For example, the pet food compositions may include tryptophan in an amount of about 5 wt. % or less, about 4 wt. % or less, about 3 wt. % or less, about 2 wt. % or less, about 1 wt. % or less, about 0.5 wt. % or less, about 0.1 wt. % or less. In at least one embodiment, the pet food composition is essentially free of or free of tryptophan.

Additionally or alternatively, the pet food compositions may include phenylalanine in an amount of about 5 wt. % or less, about 4 wt. % or less, about 3 wt. % or less, about 2 wt. % or less, about 1 wt. % or less, about 0.5 wt. % or less, about 0.1 wt. % or less. In at least one embodiment, the pet food composition is essentially free of or free of phenylalanine.

In some embodiments, the pet food compositions includes tyrosine in an amount of about 5 wt. % or less, about 4 wt. % or less, about 3 wt. % or less, about 2 wt. % or less, about 1 wt. % or less, about 0.5 wt. % or less, about 0.1 wt. % or less. In at least one embodiment, the pet food composition is essentially free of or free of tyrosine.

Suitable components, such as those listed below, may be included or excluded from the formulations for the pet food compositions depending on the specific combination of other ingredients and the form of the pet food compositions. In some embodiments, the pet food compositions disclosed herein may be in the form of a stand-alone pet food, as a supplement to pet food, as a pet food treat, or the like.

The pet food composition are formulated to include fat in an amount typically ranging from about 8 to about 50 wt. %, based on the total weight of the pet food composition on a dry matter basis. For example, the pet food composition may include fat in an amount ranging from about 8 to about 50 wt. %, about 10 to about 50 wt. %, about 12 to about 50 wt. %, about 14 to about 50 wt. %, about 16 to about 50 wt. %, about 18 to about 50 wt. %, about 20 to about 50 wt. %, about 22 to about 50 wt. %, about 24 to about 50 wt. %; from about 8 to about 40 wt. %, about 10 to about 40 wt. %, about 12 to about 40 wt. %, about 14 to about 40 wt. %, about 16 to about 40 wt. %, about 18 to about 40 wt. %, about 20 to about 40 wt. %, about 22 to about 40 wt. %, about 24 to about 40 wt. %; from about 8 to about 35 wt. %, about 10 to about 35 wt. %, about 12 to about 35 wt. %, about 14 to about 35 wt. %, about 16 to about 35 wt. %, about 18 to about 35 wt. %, about 20 to about 35 wt. %, about 22 to about 35 wt. %, about 24 to about 35 wt. %; about 8 to about 30 wt. %, about 10 to about 30 wt. %, about 12 to about 30 wt. %, about 14 to about 30 wt. %, about 16 to about 30 wt. %, about 18 to about 30 wt. %, about 20 to about 30 wt. %, about 22 to about 30 wt. %, about 24 to about 30 wt. %; from about 8 to about 27 wt. %, about 10 to about 27 wt. %, about 12 to about 27 wt. %, about 14 to about 27 wt. %, about 16 to about 27 wt. %, about 18 to about 27 wt. %, about 20 to about 27 wt. %, about 22 to about 27 wt. %; from about 8 to about 24 wt. %, about 10 to about 24 wt. %, about 12 to about 24 wt. %, about 14 to about 24 wt. %, about 16 to about 24 wt. %, about 18 to about 24 wt. %, about 20 to about 24 wt. %; from about 8 to about 22 wt. %, about 10 to about 22 wt. %, about 12 to about 22 wt. %, about 14 to about 22 wt. %, about 16 to about 22 wt. %, about 18 to about 22 wt. %; from about 8 to about 22 wt. %, about 10 to about 22 wt. %, about 12 to about 22 wt. %, about 14 to about 22 wt. %, about 16 to about 22 wt. %, about 18 to about 22 wt. %; from about 8 to about 20 wt. %, about 10 to about 20 wt. %, about 12 to about 20 wt. %, about 14 to about 20 wt. %, about 16 to about 20 wt. %, including ranges and subranges thereof, based on the total weight of the pet food composition on a dry matter basis.

The term “fat” generally refers to a lipid or mixture of lipids that may generally be a solid or a liquid at ordinary room temperatures (e.g., 25° C.) and pressures (e.g., 1 atm). In some instances, the fat may be a viscous liquid or an amorphous solid at standard room temperature and pressure. The fat may be incorporated completely within the food composition, deposited on the outside of the pet food composition, or a mixture of the two methods. In some embodiments, the pet food compositions further include an effective amount of one or more substances selected from the group consisting of glucosamine, chondroitin, chondroitin sulfate, methylsulfonylmethane (“MSM”), creatine, antioxidants, Perna canaliculata, and mixtures thereof.

Fat can be supplied by any of a variety of sources known by those skilled in the art, including meat, meat by-products, canola oil, fish oil such as anchovy oil and menhaden oil, and plants. Meat fat sources include poultry fat, turkey fat, pork fat, lard, tallow, and beef fat. Plant fat sources include wheat, flaxseed, rye, barley, rice, sorghum, corn, oats, millet, wheat germ, corn germ, soybeans, peanuts, and cottonseed, as well as oils derived from these and other plant fat sources such as corn oil, soybean oil, cottonseed oil, palm oil, palm kernel oil, linseed oil, canola oil, rapeseed oil, and/or olestra.

In some cases, the fat in the compositions is crude fat. Crude fat may be included into the compositions in the amounts disclosed above with respect of the total fat, such as from about 8 to about 50 wt. %, based on the total weight of the pet food composition on a dry matter basis. In some embodiments, the pet food composition comprises crude fat in an amount of about 10 to about 40 wt. %, about 12 to about 35 wt. %, about 14 to about 30 wt. %, about 16 to about 24 wt. %, based on the total weight of the pet food composition on a dry matter basis. In some cases, it may be preferable that about 50 wt. % or more, about 60 wt. % or more, about 70 wt. % or more, about 80 wt. % or more, or about 90 wt. % or more of the total fat is obtained from an animal source. Alternatively, about 50 wt. % or more, about 60 wt. % or more, about 70 wt. % or more, about 80 wt. % or more, or about 90 wt. % or more of the total fat may be obtained from a plant source.

The pet food compositions typically include protein in an amount ranging from about 15 to about 50 wt. %, based on the total weight of the pet food composition on a dry matter basis. In some instances, the total amount of protein in the pet food composition is in a range from about 15 to about 48 wt. %, about 15 to about 46 wt. %, about 15 to about 44 wt. %, about 15 to about 42 wt. %, about 15 to about 40 wt. %, about 15 to about 38 wt. %, about 15 to about 36 wt. %, about 15 to about 34 wt. %; about 20 to about 50 wt. %, about 20 to about 48 wt. %, about 20 to about 46 wt. %, about 20 to about 44 wt. %, about 20 to about 42 wt. %, about 20 to about 40 wt. %, about 20 to about 38 wt. %, about 20 to about 36 wt. %, about 20 to about 34 wt. %; about 25 to about 50 wt. %, about 25 to about 48 wt. %, about 25 to about 46 wt. %, about 25 to about 44 wt. %, about 25 to about 42 wt. %, about 25 to about 40 wt. %, about 25 to about 38 wt. %, about 25 to about 36 wt. %, about 25 to about 34 wt. %; about 30 to about 50 wt. %, about 30 to about 48 wt. %, about 30 to about 46 wt. %, about 30 to about 44 wt. %, about 30 to about 42 wt. %, about 30 to about 40 wt. %, about 30 to about 38 wt. %, or about 30 to about 36 wt. %, including ranges and subranges therebetween, based on the total weight of the pet food composition on a dry matter basis.

The protein of the pet food composition comprises one or more amino acids selected from glycine, proline, or a combination of two more thereof. Preferably, the pet food composition comprises two or more amino acids. For instance, the pet food composition may include two or more, three or more, four or more, five or more, six or more, seven or more, eight or more amino acids. In some embodiments, the pet food composition includes glycine and proline, and optionally one or more additional amino acids.

The one or more amino acids may be selected from Tryptophan, Taurine, Histidine, Carnitine, Carnosine, Alanine, Cysteine, Arginine, Methionine (including DL-methionine, and L-methionine), Tryptophan, Lysine, Asparagine, Aspartate (Aspartic acid), Phenylalanine, Valine, Threonine, Isoleucine, Histidine, Leucine, Glycine, Glutamine, Taurine, Tyrosine, Homocysteine, Ornithine, Citruline, Glutamate (Glutamic acid), Proline, and/or Serine, and a combination of two or more thereof. In some cases, the one or more amino acid(s) may comprise essential amino acids. Essential amino acids are amino acids that cannot be synthesized de novo, or in sufficient quantities by an organism and thus must be supplied in the diet. Essential amino acids vary from species to species, depending upon the organism's metabolism. For example, it is generally understood that the essential amino acids for dogs and cats (and humans) are phenylalanine, leucine, methionine, lysine, isoleucine, valine, threonine, tryptophan, histidine and arginine. In addition, taurine, while technically not an amino acid but a derivative of cysteine, is an essential nutrient for cats.

A portion of the protein in the composition may be digestible protein. For example, the composition may include an amount of protein, where about 40 wt. % or more, about 50 wt. % or more, about 60 wt. % or more, about 70 wt. % or more, about 80 wt. % or more, about 90 wt. % or more, about 95 wt. % or more, about 98 wt. % or more, or about 99 wt. % or more of the protein is digestible protein. In some embodiments, e.g., when the composition desirable promotes weight loss, the portion of protein that is digestible protein is about 60 wt. % or less, about 50 wt. % or less, about 40 wt. % or less, about 30 wt. % or less, about 20 wt. % or less, or about 10 wt. % or less, based on the total amount of protein in the pet food composition on a dry matter basis. In further embodiment, the amount of protein that is digestible protein is about 10 to about 99 wt. %, about 10 to about 95 wt. %, about 10 to about 90 wt. %, about 10 to about 70 wt. %, about 10 to about 50 wt. %, about 10 to about 30 wt. %; about 30 to about 99 wt. %, about 30 to about 95 wt. %, about 30 to about 90 wt. %, about 30 to about 70 wt. %, about 30 to about 50 wt. %; about 50 to about 99 wt. %, about 50 to about 95 wt. %, about 50 to about 90 wt. %, about 50 to about 70 wt. %; about 70 to about 99 wt. %, about 70 to about 95 wt. %, or about 70 to about 90 wt. %, including ranges and subranges therein, based on the total amount of protein in the pet food composition on a dry matter basis.

Protein may be supplied by any of a variety of sources known by those of ordinary skill in the art including plant sources, animal sources, microbial sources or a combination of these. For example, animal sources may include meat, meat-by products, seafood, dairy, eggs, etc. Meats, for example, may include animal flesh such as poultry, fish, and mammals including cattle, pigs, sheep, goats, and the like. Meat by-products may include, for example, lungs, kidneys, brain, livers, stomachs and intestines. Plant protein includes, for example, soybean, cottonseed, and peanuts. Microbial sources may be used to synthesize amino acids (e.g., lysine, threonine, tryptophan, and/or methionine) or intact protein such as protein from sources listed below.

Examples of protein or protein ingredients may comprise chicken meals, chicken, chicken by-product meals, lamb, lamb meals, turkey, turkey meals, beef, beef by-products, viscera, fish meal, enterals, kangaroo, white fish, venison, soybean meal, soy protein isolate, soy protein concentrate, corn gluten meal, corn protein concentrate, distillers dried grains, and/or distillers dried grain solubles and single-cell proteins, for example yeast, algae, and/or bacteria cultures.

The protein can be intact, completely hydrolyzed, or partially hydrolyzed. The protein content of foods may be determined by any number of methods known by those of skill in the art, for example, as published by the Association of Official Analytical Chemists in Official Methods of Analysis (“OMA”), method 988.05. The amount of protein in a composition disclosed herein may be determined based on the amount of nitrogen in the composition according to methods familiar to one of skill in the art.

The pet food compositions are typically formulated to include fiber in an amount from about 3.5 to about 35 wt. %, based on the total weight of the pet food composition on a dry matter basis. For example, the total amount of fiber present in the pet food composition may be from about 3.5 to about 32 wt. %, about 3.5 to about 29 wt. %, about 3.5 to about 26 wt. %, about 3.5 to about 24 wt. %, about 3.5 to about 22 wt. %, about 3.5 to about 20 wt. %, about 3.5 to about 18 wt. %, about 3.5 to about 16 wt. %; about 5 to about 35 wt. %, about 5 to about 32 wt. %, about 5 to about 29 wt. %, about 5 to about 26 wt. %, about 5 to about 24 wt. %, about 5 to about 22 wt. %, about 5 to about 20 wt. %, about 5 to about 18 wt. %, about 5 to about 16 wt. %; about 8 to about 35 wt. %, about 8 to about 32 wt. %, about 8 to about 29 wt. %, about 8 to about 26 wt. %, about 8 to about 24 wt. %, about 8 to about 22 wt. %, about 8 to about 20 wt. %, about 8 to about 18 wt. %, about 8 to about 16 wt. %; about 11 to about 35 wt. %, about 11 to about 32 wt. %, about 11 to about 29 wt. %, about 11 to about 26 wt. %, about 11 to about 24 wt. %, about 11 to about 22 wt. %, about 11 to about 20 wt. %, about 11 to about 18 wt. %, about 11 to about 16 wt. %; about 14 to about 35 wt. %, about 14 to about 32 wt. %, about 14 to about 29 wt. %, about 14 to about 26 wt. %, about 14 to about 24 wt. %, about 14 to about 22 wt. %, about 14 to about 20 wt. %, about 14 to about 18 wt. %; about 16 to about 35 wt. %, about 16 to about 32 wt. %, about 16 to about 29 wt. %, about 16 to about 26 wt. %, about 16 to about 24 wt. %, about 16 to about 22 wt. %, about 16 to about 20 wt. %; about 18 to about 35 wt. %, about 18 to about 32 wt. %, about 18 to about 29 wt. %, about 18 to about 26 wt. %, about 18 to about 24 wt. %, about 18 to about 22 wt. %; about 20 to about 35 wt. %, about 20 to about 32 wt. %, about 20 to about 29 wt. %, about 20 to about 26 wt. %, about 20 to about 24 wt. %; about 22 to about 35 wt. %, about 22 to about 32 wt. %, about 22 to about 29 wt. %, about 22 to about 26 wt. %; about 24 to about 35 wt. %, about 24 to about 32 wt. %, about 24 to about 29 wt. %; about 26 to about 35 wt. %, about 26 to about 32 wt. %, about 26 to about 29 wt. %; about 28 to about 35 wt. %, or about 28 to about 32 wt. %, including ranges and subranges thereof, based on the total weight of the pet food composition on a dry matter basis.

The total amount of fiber present in the pet food composition generally comprises an amount of crude fiber and dietary fiber. The amount of crude fiber and/or dietary fiber may be present in the pet food compositions in any of the above amounts disclosed for the total amount of fiber. Crude fiber includes indigestible components contained in cell walls and cell contents of plants such as grains, e.g., hulls of grains such as rice, corn, and beans.

Dietary fiber refers to components of a plant that are resistant to digestion by an animal's digestive enzymes. Dietary fiber includes soluble fiber and insoluble fiber. Soluble fibers are resistant to digestion and absorption in the small intestine and undergo complete or partial fermentation in the large intestine, e.g., beet pulp, guar gum, chicory root, psyllium, pectin, blueberry, cranberry, squash, apples, oats, beans, citrus, barley, or peas. Insoluble fibers can be supplied by any of a variety of sources, including, for example, cellulose, whole-wheat products, wheat oat, corn bran, flax seed, grapes, celery, green beans, cauliflower, potato skins, fruit skins, vegetable skins, peanut hulls, and soy fiber. Crude fiber includes indigestible components contained in cell walls and cell contents of plants such as grains, for example, hulls of grains such as rice, corn, and beans.

In some embodiments, the pet food composition has a weight ratio of insoluble fiber to soluble fiber from about 20:1 to about 8:1. For example, the pet food composition may have a weight ratio of insoluble fiber to soluble fiber from about 18:1 to about 8:1, about 16:1 to about 8:1, about 14:1 to about 8:1, about 12:1 to about 8:1, about 10:1 to about 8:1, or any range or subrange thereof. The pet food composition may have a weight ratio of insoluble fiber to soluble fiber of about 11:1.

Additionally and/or alternatively, the fiber component of the pet food composition may comprise an acid detergent fiber and/or a neutral detergent fiber. In some instances, the pet food composition includes an acid detergent fiber and a neutral detergent fiber, e.g., in an amount that is from about 6 to about 20 wt. %, based on the total weight of the pet food composition on a dry matter basis. For example, the pet food composition may include one of an acid detergent fiber and/or a neutral detergent fiber in an amount from about 3 to about 15 wt. %, about 3 to about 12 wt. %, about 3 to about 10 wt. %, about 3 to about 8 wt. %, about 3 to about 6 wt. %, about 3 to about 5 wt. %; about 5 to about 15 wt. %, about 5 to about 12 wt. %, about 5 to about 10 wt. %, about 5 to about 8 wt. %, about 5 to about 6 wt. %; about 7 to about 15 wt. %, about 7 to about 12 wt. %, about 7 to about 10 wt. %, about 7 to about 8 wt. %; about 9 to about 15 wt. %, about 9 to about 12 wt. %, about 9 to about 10 wt. %; about 11 to about 15 wt. %, about 11 to about 13 wt. %, or about 12 to about 15 wt. %, including ranges and subranges thereof, based on the total weight of the pet food composition on a dry matter basis.

In some embodiments, the pet food composition has a weight ratio of the acid detergent fiber to the neutral detergent fiber of from about 3:1 to about 1:3. Preferably, the weight ratio of the acid detergent fiber to the neutral detergent fiber is from about 2:1 to about 1:2. In some instances, the weight ratio of the acid detergent fiber to the neutral detergent fiber is from about 1.75:1 to about 1:1.75, about 1.5:1 to about 1:1.5, about 1.25:1 to about 1:1.25, or any range or subrange thereof. In at least one embodiment, the weight ratio of the acid detergent fiber to the neutral detergent fiber is about 1:1.

The fiber in the pet food compositions may be supplied by a variety of sources known by those skilled in the art. Preferably, the fiber in the pet food compositions is supplied by Teff, Wheat, Oats, Rice, Corn, Barley, Sorghum, Rye, Millet, Triticale, Amaranth, Buckwheat, Quinoa.

The pet food compositions may include one or more triglycerides. In some cases, the pet food composition includes two or more triglycerides, three or more triglycerides, four or more triglycerides, or five or more triglycerides. Preferably, at least one triglyceride is a medium chain triglyceride. The medium chain triglyceride comprises an aliphatic carbon chain comprising from 6 to 10 carbons. In some embodiments, the medium chain triglyceride has an aliphatic carbon chain of 6 carbons, 7 carbons, 8 carbons, 9 carbons, 10 carbons, or a range thereof. For example, the aliphatic carbon chain of the medium chain triglyceride may range from 6 to 9 carbons, 6 to 8 carbons, 6 or 7 carbons; 7 to 10 carbons, 7 to 9 carbons, 7 or 8 carbons; 8 to 10 carbons, or 8 or 9 carbons, or 9 or 10 carbons. In at least one embodiment, the medium chain triglyceride comprises a caprylate component, a caprate component, a residue thereof, or a combination thereof. In further embodiments, the pet food composition includes caprylate and caprate.

The triglyceride may comprise dietary fat in an amount up to about 100%. In some instances, the fat of the pet food composition consists of or consists essentially of dietary fat. Preferably, the dietary fat comprises triglyceride(s). In some embodiments, the triglyceride may comprise about 20 to about 100%, about 40 to about 100%, about 50 to about 100%, about 60 to about 100%, about 70 to about 100%, about 80 to about 100%, about 90 to about 100%, of the total amount of fat in the pet food composition. In further embodiments, the triglyceride comprises about 20 to about 95%, about 40 to about 95%, about 50 to about 95%, about 60 to about 95%, about 70 to about 95%, about 80 to about 95%, about 90 to about 95%, of the total amount of fat in the pet food composition. In additional embodiments, the triglyceride comprises about 20 to about 90%, about 40 to about 90%, about 50 to about 90%, about 60 to about 90%, about 70 to about 90%, about 80 to about 90%, of the total amount of fat in the pet food composition. In yet further embodiment, the triglyceride comprises about 20 to about 80%, about 40 to about 80%, about 50 to about 80%, about 60 to about 80%, about 70 to about 80%, of the total amount of fat in the pet food composition.

The triglyceride(s) may, additionally or alternatively, be present in the pet food compositions in an amount from about 8 to about 50 wt. %, based on the total weight of the pet food composition on a dry matter basis. For example, amount of triglyceride in the pet food composition may be from about 8 to about 50 wt. %, about 10 to about 50 wt. %, about 12 to about 50 wt. %, about 14 to about 50 wt. %, about 16 to about 50 wt. %, about 18 to about 50 wt. %, about 20 to about 50 wt. %, about 22 to about 50 wt. %, about 24 to about 50 wt. %; from about 8 to about 40 wt. %, about 10 to about 40 wt. %, about 12 to about 40 wt. %, about 14 to about 40 wt. %, about 16 to about 40 wt. %, about 18 to about 40 wt. %, about 20 to about 40 wt. %, about 22 to about 40 wt. %, about 24 to about 40 wt. %; from about 8 to about 35 wt. %, about 10 to about 35 wt. %, about 12 to about 35 wt. %, about 14 to about 35 wt. %, about 16 to about 35 wt. %, about 18 to about 35 wt. %, about 20 to about 35 wt. %, about 22 to about 35 wt. %, about 24 to about 35 wt. %; about 8 to about 30 wt. %, about 10 to about 30 wt. %, about 12 to about 30 wt. %, about 14 to about 30 wt. %, about 16 to about 30 wt. %, about 18 to about 30 wt. %, about 20 to about 30 wt. %, about 22 to about 30 wt. %, about 24 to about 30 wt. %; from about 8 to about 27 wt. %, about 10 to about 27 wt. %, about 12 to about 27 wt. %, about 14 to about 27 wt. %, about 16 to about 27 wt. %, about 18 to about 27 wt. %, about 20 to about 27 wt. %, about 22 to about 27 wt. %; from about 8 to about 24 wt. %, about 10 to about 24 wt. %, about 12 to about 24 wt. %, about 14 to about 24 wt. %, about 16 to about 24 wt. %, about 18 to about 24 wt. %, about 20 to about 24 wt. %; from about 8 to about 22 wt. %, about 10 to about 22 wt. %, about 12 to about 22 wt. %, about 14 to about 22 wt. %, about 16 to about 22 wt. %, about 18 to about 22 wt. %; from about 8 to about 22 wt. %, about 10 to about 22 wt. %, about 12 to about 22 wt. %, about 14 to about 22 wt. %, about 16 to about 22 wt. %, about 18 to about 22 wt. %; from about 8 to about 20 wt. %, about 10 to about 20 wt. %, about 12 to about 20 wt. %, about 14 to about 20 wt. %, about 16 to about 20 wt. %, including ranges and subranges thereof, based on the total weight of the pet food composition on a dry matter basis.

The triglyceride may include one or more constituents that comprise a fatty acid(s) component/moiety. For example, the triglyceride may include one, two, or three aplanatic chains that are selected from fatty acid component. Non-limiting examples of fatty acid components include, but are not limited to, omega-3 fatty acids, omega-6 fatty acids, lauric acid, myristic acid, palmitic acid, palmitoleic acid, margaric acid, margaroleic acid, stearic acid, oleic acid, stearidonic acid, gadoleic acid, behenic acid, erucic acid, docosatetra acid, and a combination of two or more thereof. The fatty acid(s) moieties may be a polyunsaturated fatty acid, such as an omega-3 fatty acid, an omega-6 fatty acid, or a combination of two or more thereof. Non-limiting examples of omega-3 fatty acid components include those selected from linolenic acid, stearidonic acid, eicosatetraenoic acid, eicosapentaenoic acid, docosapentaenoic acid, docosahexaenoic acid, and a combination of two or more thereof.

Additionally or alternatively, the triglyceride may include a polyunsaturated fatty acid component selected from omega-6 fatty acids. Examples of omega-6 fatty acid moieties include linolenic acid, calendic acid, eicosadienoic acid, arachidonic acid, docosadienoic acid, adrenic acid, osbond acid, tetracosatetraenoic acid, tetracosapentaenoic acid, or a combination of two or more thereof. In some embodiments, the polyunsaturated fatty acid component is selected from linolenic acid, arachidonic acid, and a combination of two or more thereof.

In at least one preferred embodiment, the pet food composition includes at least one triglyceride, such as a medium chain triglyceride, having at least aliphatic chain constituent selected from a fatty acid component from the aforementioned list, such as an omega-3 fatty acid.

The pet food compositions may include betaine, e.g., in an amount of from 0.01 to about 5 wt., based on the total weight of the pet food composition on a dry matter basis. For example, amount of betaine in the pet food composition may be from about 0.01 to about 4 wt. %, about 0.01 to about 3 wt. %, about 0.01 to about 2 wt. %, about 0.01 to about 1 wt. %; about 0.05 to about 5 wt. %, about 0.05 to about 4 wt. %, about 0.05 to about 3 wt. %, about 0.05 to about 2 wt. %, about 0.05 to about 1 wt. %; about 0.1 to about 5 wt. %, about 0.1 to about 4 wt. %, about 0.1 to about 3 wt. %, about 0.1 to about 2 wt. %, about 0.1 to about 1 wt. %; from about 0.2 to about 5 wt. %, about 0.2 to about 4 wt. %, about 0.2 to about 3 wt. %, about 0.2 to about 2 wt. %, about 0.2 to about 1 wt. %; from about 0.5 to about 5 wt. %, about 0.5 to about 4 wt. %, about 0.5 to about 3 wt. %, about 0.5 to about 2 wt. %, about 0.5 to about 1 wt. %; from about 0.75 to about 5 wt. %, about 0.75 to about 4 wt. %, about 0.75 to about 3 wt. %, about 0.75 to about 2 wt. %, about 0.75 to about 1 wt. %; from about 1 to about 5 wt. %, about 1 to about 4 wt. %, about 1 to about 3 wt. %, about 1 to about 2 wt. %; from about 2 to about 5 wt. %, about 2 to about 4 wt. %, about 2 to about 3 wt. %; from about 3 to about 5 wt. %, about 3 to about 4 wt. %, or any range or subrange thereof, based on the total weight of the pet food composition on a dry matter basis.

The pet food compositions, in some preferable embodiments, includes one or more vitamins. The one or more vitamin(s) in the pet food composition may be selected from a vitamin B. Suitable vitamin Bs that may be incorporated in the pet food composition include those selected from thiamin, riboflavin, niacin, pantothenic acid, pyridoxine, biotin, folic acid, cobalamin, and a combination of two or more thereof. In some cases, the pet food compositions include 2 or more, 3 or more, or 4 or more vitamins selected from thiamin, riboflavin, niacin, pantothenic acid, pyridoxine, biotin, folic acid, cobalamin, and a combination of two or more thereof. In at least one embodiment, the one or more vitamin B comprises thiamin, riboflavin, niacin, pantothenic acid, pyridoxine, biotin, or a combination of two or more thereof. In other embodiments, the one or more vitamin B comprises at least three vitamins selected from the group consisting of thiamin, riboflavin, niacin, pantothenic acid, pyridoxine, biotin, folic acid, cobalamin, and a combination of two or more thereof.

The pet food compositions may include one or more vitamin B in certain amounts, such as thiamin in an amount of from about 8 to about 20 mg/100 g, pyridoxine in an amount of from about 1 to about 4 mg/100 g, cobalamin in an amount of from about 10 to about 40 ug/100 g, and/or folic acid in an amount of from about 100 to about 400 ug/100 g. The amount of thiamin in the pet food composition may be from about 8 to about 20 mg/100 g, about 11 to about 20 mg/100 g, about 14 to about 20 mg/100 g, about 16 to about 20 mg/100 g, about 8 to about 17 mg/100 g, about 8 to about 14 mg/100 g, about 8 to about 11 mg/100 g, or any ranges or subranges thereof. The amount of pyridoxine in the pet food composition may, in some instances, be from about 1 to about 4 mg/100 g, about 2 to about 4 mg/100 g, about 3 to about 4 mg/100 g, about 1 to about 3 mg/100 g, about 1 to about 2 mg/100 g, or any ranges and subranges thereof. Cobalamin may be present in the pet food composition in an amount from about 10 to about 40 ug/100 g, about 15 to about 40 ug/100 g, about 20 to about 40 ug/100 g, about 25 to about 40 ug/100 g, about 30 to about 40 ug/100 g, about 35 to about 40 ug/100 g, about 10 to about 35 ug/100 g, about 10 to about 30 ug/100 g, about 10 to about 25 ug/100 g, about 10 to about 20 ug/100 g, about 10 to about 15 ug/100 g, or any ranges and subranges thereof. Additionally or alternatively, the pet food composition may include folic acid in an amount of from about 100 to about 400 ug/100 g, about 100 to about 400 ug/100 g, about 150 to about 400 ug/100 g, about 200 to about 400 ug/100 g, about 250 to about 400 ug/100 g, about 300 to about 400 ug/100 g, about 350 to about 400 ug/100 g, about 100 to about 350 ug/100 g, about 100 to about 300 ug/100 g, about 100 to about 250 ug/100 g, about 100 to about 200 ug/100 g, about 100 to about 150 ug/100 g, or any ranges and subranges thereof. In at least one embodiment, the pet food composition includes thiamin in an amount of from about 8 to about 20 mg/100 g, pyridoxine in an amount of from about 1 to about 4 mg/100 g, cobalamin in an amount of from about 10 to about 40 ug/100 g, and folic acid in an amount of from about 100 to about 400 ug/100 g.

Certain embodiments of the pet food composition are formulated to have a weight ratio of folic acid to cobalamin of from about 1:1 to about 50:1. For example, the weight ratio of folic acid to cobalamin in the pet food composition may be from about 1:1 to about 40:1, about 1:1 to about 35:1, about 1:1 to about 30:1, about 1:1 to about 25:1, about 1:1 to about 20:1, about 1:1 to about 15:1; about 3:1 to about 50:1, about 3:1 to about 40:1, about 3:1 to about 35:1, about 3:1 to about 30:1, about 3:1 to about 25:1, about 3:1 to about 20:1, about 3:1 to about 15:1; about 5:1 to about 50:1, about 5:1 to about 40:1, about 5:1 to about 35:1, about 5:1 to about 30:1, about 5:1 to about 25:1, about 5:1 to about 20:1, or about 5:1 to about 15:1, including ranges or subranges thereof.

The pet food composition may include a weight ratio of thiamin to pyridoxine of from about 1:1 to about 30:1. In some instances, the pet food composition includes a weight ratio of thiamin to pyridoxine of from about 1:1 to about 25:1, about 1:1 to about 20:1, about 1:1 to about 15:1, about 1:1 to about 10:1, about 1:1 to about 7:1, about 1:1 to about 5:1; about 2:1 to about 30:1, about 2:1 to about 25:1, about 2:1 to about 20:1, about 2:1 to about 15:1, about 2:1 to about 10:1, about 2:1 to about 7:1, about 2:1 to about 5:1, or any range or subrange thereof.

The pet food composition may further comprise ash. As described herein, ash consists of compounds that are not organic or water, generally produced by combustion of biological materials. The ash may be present in the pet food composition in an amount ranging from about 1 to about 10 wt. %, based on the total weight of the food composition on a dry weight basis, including all amounts and sub-ranges there-between. In some embodiment, the ash may be present in the food composition in an amount ranging from about 2.5 to about 7.5 wt. %, based on the total weight of the food composition on a dry weight basis, including all amounts and subranges thereof.

Additionally or alternatively, the pet food composition may include carbohydrates, e.g., in an amount up to about 65 wt. %, based on the total weight of the pet food composition on a dry matter basis. The term “carbohydrate” as used herein includes polysaccharides (e.g., starches and dextrins) and sugars (e.g., sucrose, lactose, maltose, glucose, and fructose) that are metabolized for energy when hydrolyzed. One skilled in the art could manipulate the texture of the final product by properly balancing carbohydrate sources. For example, short chain polysaccharides lend to be sticky and gluey, and longer chain polysaccharides are less sticky and gluey than the shorter chain; the desired texture of this hybrid food is achieved by longer chain polysaccharide and modified starches such as native or modified starches, cellulose and the like. The carbohydrate mixture may additionally comprise optional components such as added salt, spices, seasonings, vitamins, minerals, flavorants, colorants, and the like. The amount of the optional components is at least partially dependent on the nutritional requirements for different life stages of animals.

Carbohydrates can be supplied by any of a variety of sources known by those skilled in the art, including, but not limited to, oat fiber, cellulose, peanut hulls, beet pulp, parboiled rice, cornstarch, corn gluten meal, cereal, and sorghum. Grains supplying carbohydrates can include, but are not limited to, wheat, durum, semolina, corn, barley, and rice. In certain embodiments, the carbohydrate component comprises a mixture of one or more carbohydrate sources. Carbohydrates content of foods can be determined by any number of methods known by those of skill in the art.

Generally, carbohydrate percentage can be calculated as nitrogen free extract (“NFE”), which can be calculated as follows: NFE %=100%−(moisture %)−(protein %)−(fat %)−(ash %)−(crude fiber %) The amount of carbohydrate, e.g., calculated as NFE, present in the composition may be from an amount up to about 65 wt. %, an amount up to about 60 wt. %, an amount up to about 55 wt. %, an amount up to about 50 wt. %, an amount up to about 45 wt. %, an amount up to about 40 wt. %, an amount up to about 35 wt. %, an amount up to about 30 wt. %, an amount up to about 25 wt. %, an amount up to about 20 wt. %, an amount up to about 15 wt. %, an amount up to about 10 wt. %, an amount up to about 5 wt. %; about 1 to about 65 wt. %, about 1 to about 55 wt. %, about 1 to about 50 wt. %, about 1 to about 45 wt. %, about 1 to about 40 wt. %, about 1 to about 35 wt. %; about 1 to about 30 wt. %, about 1 to about 25 wt. %, about 1 to about 20 wt. %, about 1 to about 15 wt. %, about 1 to about 10 wt. %, about 1 to about 5 wt. %; about 5 to about 65 wt. %, about 5 to about 55 wt. %, about 5 to about 50 wt. %, about 5 to about 45 wt. %, about 5 to about 40 wt. %, about 5 to about 35 wt. %; about 5 to about 30 wt. %, about 5 to about 25 wt. %, about 5 to about 20 wt. %, about 5 to about 15 wt. %; about 10 to about 65 wt. %, about 10 to about 55 wt. %, about 10 to about 50 wt. %, about 10 to about 45 wt. %, about 10 to about 40 wt. %, about 10 to about 35 wt. %; about 10 to about 30 wt. %, about 10 to about 25 wt. %; about 15 to about 65 wt. %, about 15 to about 55 wt. %, about 15 to about 50 wt. %, about 15 to about 45 wt. %, about 15 to about 40 wt. %, about 15 to about 35 wt. %; about 15 to about 30 wt. %; about 20 to about 65 wt. %, about 20 to about 55 wt. %, about 20 to about 50 wt. %, about 20 to about 45 wt. %, about 20 to about 40 wt. %, about 20 to about 35 wt. %; about 25 to about 65 wt. %, about 25 to about 55 wt. %, about 25 to about 50 wt. %, about 25 to about 45 wt. %, about 25 to about 40 wt. %, about 25 to about 35 wt. %; about 30 to about 65 wt. %, about 30 to about 55 wt. %, about 30 to about 50 wt. %, about 30 to about 45 wt. %; about 35 to about 65 wt. %, about 35 to about 55 wt. %, about 35 to about 50 wt. %; about 40 to about 65 wt. %, about 40 to about 55 wt. %, about 45 to about 65 wt. %, about 45 to about 55 wt. %; or about 50 to about 65 wt. %, including ranges and subranges thereof, based on the total weight of the pet composition on a dry matter basis.

In certain embodiments, the pet food composition comprises moisture. The moisture may be present at various amounts or concentrations. In one embodiment, moisture may be present in an amount of from about 3 to about 20 wt. %, based on the total weight of the pet food composition. For example, moisture may be present in an amount of about 3 wt. %, about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, about 10 wt. %, about 10.5 wt. %, about 11 wt. %, about 11.5 wt. %, about 12 wt. %, about 12.5 wt. %, about 13 wt. %, about 13.5 wt. %, about 14 wt. %, about 14.5 wt. %, or about 15 wt. %, based on the total weight of the pet food composition. In another example, moisture may be present in an amount of from about 6% to about 12%, about 9% to about 13%, about 9% to about 11%, or about 9% to about 13%, based on the total weight of the pet food composition. In certain embodiments, moisture is present in an amount of about 5% to about 12%, about 6% to about 11%, or about 7% to about 10.0%, based on the total weight of the pet food composition. In further embodiments, moisture is present in an amount of about 65% to about 85%, about 60% to about 80%, or about 60% to about 75%, based on the total weight of the pet food composition.

The pet food compositions may include one or more ingredients and/or sources of glucose mimetic, carotenoids, and/or arginine and derivatives thereof. Sources of glucose mimetics may comprise glucose anti-metabolites including 2-deoxy-D-glucose, 5-thio-D-glucose, 3-O-methylglucose, anhydrosugars including 1,5-anhydro-D-glucitol, 2,5-anhydro-D-glucitol, 2,5-anhydro-D-mannitol, mannoheptulose, and/or avocado extract comprising mannoheptulose. Sources of carotenoids may include lutein, astaxanthin, zeaxanthin, bixin, lycopene, and/or beta-carotene. Sources of antioxidant ingredients may comprise tocopherols (vitamin E), vitamin C, vitamin A, plant-derived materials, carotenoids (described above), selenium, and/or CoQ10 (Co-enzyme Q10). In a preferred embodiment, the pet food composition contains high levels of arginine and derivatives thereof. The amount of arginine present in the composition may be about 0.01 to about 10.0 wt. %, about 0.01 to about 5.0 wt. %, about 0.01 to about 2.0 wt. %, about 0.1 to about 10.0 wt. %, about 0.1 to about 5.0 wt. %, about 0.1 to about 2.0 wt. %; about 0.5 to about 5.0 wt. %, about 0.5 to about 2.0 wt. %, about 1.5 to about 5.0 wt. %, about 1.5 to about 2.0 wt. %, about 0.5 wt. %, about 1.0 wt. %, about 1.4 wt. %, about 1.44 wt. %, about 1.8 wt. %, about 2.0 wt. %, or any range or subrange thereof, based on the total weight of the composition on a dry matter basis. The arginine present in the composition may be L-arginine, D-arginine, or a mixture thereof.

The pet food compositions disclosed herein may be wet or dry compositions, and the ingredients can be either incorporated into the food composition and/or on the surface of any composition component, such as, for example, by spraying, agglomerating, dusting, or precipitating on the surface. Additionally, the pet food compositions may be formulated and produced to be in various forms and/or consistencies. For instance, the pet food compositions may, for example, be a dry, moist or semi-moist animal food composition. “Semi-moist” refers to a food composition containing from about 25 to about 35 wt. % moisture. “Moist” food refers to a food composition that has a moisture content of about 60 to 90 wt. % or greater. “Dry” food refers to a food composition with about 3 to about 12 wt. % moisture content and is often manufactured in the form of small bits or kibbles.

The food products may also include components of more than one consistency, for example, soft, chewy meat-like particles or pieces as well as kibble having an outer coating and an inner “core” component. In some embodiments, the pet food compositions may be in the form of a kibble or food kibble. As used herein, the term “kibble” or “food kibble” refers to a particulate pellet, e.g., like a component of feline or canine feeds. In some embodiments, a food kibble has a moisture, or water content of less than 15 wt. % by weight. Food kibbles may range in texture from hard to soft. Food kibbles may range in internal structure from expanded to dense. Food kibbles may be formed by an extrusion process or a baking process. In non-limiting examples, a food kibble may have a uniform internal structure or a varied internal structure. For example, a food kibble may include a core and a coating to form a coated kibble. It should be understood that when the term “kibble” or “food kibble” is used, it can refer to an uncoated kibble or a coated kibble.

The composition of the present disclosure can additionally comprise other additives in amounts and combinations familiar to one of skill in the art. Such additives should be present in amounts that do not impair the purpose and effect provided by the invention. Examples of additives include substances with a stabilizing effect, organoleptic substances, processing aids, and substances that provide nutritional benefits.

Stabilizing substances may include, by way of example, substances that tend to increase the shelf life of the pet food composition. Other examples of other such additives potentially suitable for inclusion in the compositions of the invention include, for example, preservatives, antioxidants, synergists and sequestrants, packaging gases, stabilizers, emulsifiers, thickeners, gelling agents, and humectants. Examples of emulsifiers and/or thickening agents include gelatin, cellulose ethers, starch, starch esters, starch ethers, and modified starches. Additives for coloring, palatability, and nutritional purposes can include colorants, salts (including, but not limited to, sodium chloride, potassium citrate, potassium chloride, and other edible salts), vitamins, minerals, and flavoring. Other additives can include glucosamine, chondroitin sulfate, vegetable extracts, herbal extracts, etc.

The concentration of such additives in the pet food composition typically can be up to about 5 wt. %, based on the total weight of the pet food composition on a dry matter basis. For example, the additives may be present in an amount from about 0.01 to about 5 wt. %, about 0.01 to about 4 wt. %, about 0.01 to about 4 wt. %, about 0.01 to about 3 wt. %, about 0.01 to about 2 wt. %, about 0.01 to about 1 wt. %; about 0.1 to about 5 wt. %, about 0.1 to about 4 wt. %, about 0.1 to about 4 wt. %, about 0.1 to about 3 wt. %, about 0.1 to about 2 wt. %, about 0.1 to about 1 wt. %; about 1 to about 5 wt. %, about 1 to about 4 wt. %, about 1 to about 4 wt. %, about 1 to about 3 wt. %, about 1 to about 2 wt. %; about 2 to about 5 wt. %, about 2 to about 4 wt. %, about 2 to about 4 wt. %, about 2 to about 3 wt. %; about 3 to about 5 wt. %, about 3 to about 4 wt. %; or about 4 to about 5 wt. %, based on the total weight of the pet food composition on a dry matter basis. In some embodiments, the concentration of such additives (particularly where such additives are primarily nutritional balancing agents, such as vitamins and minerals) is from about 0 to about 2 wt. %, based on the total weight of the pet food composition on a dry matter basis. The amount of additives comprising vitamins may be in addition to the amount of vitamin B discussed above. In some embodiments, the concentration of such additives (again, particularly where such additives are primarily nutritional balancing agents) is from about 0 to about 1 wt. %, based on the total weight of the pet food composition on a dry matter basis. Although the list of foregoing additives may be potentially suitable in some embodiments, one or more of the foregoing additives may be excluded from other embodiments of the pet food composition.

In specific embodiments, the pet food compositions and food products are formulated to address specific nutritional differences between species and breeds of animals, as well as one of more of the attributes of the animal. For example, cat foods, for example, are typically formulated based upon the life stage, age, size, weight, body composition, and breed.

Sources of proteins, carbohydrates, fats, vitamins, minerals, balancing agents, and the like, suitable for inclusion in the pet food compositions, and particularly in the food products to be administered in methods provided herein, may be selected from among those conventional materials known to those of ordinary skill in the art.

The pet food compositions may include, or in some instance exclude, one or more ingredients selected from beef broth, brewers dried yeast, egg, egg product, flax meal, DL methionine, amino acids, leucine, lysine, arginine, cysteine, cystine, aspartic acid, polyphosphates, sodium pyrophosphate, sodium tripolyphosphate; zinc chloride, copper gluconate, stannous chloride, stannous fluoride, sodium fluoride, triclosan, glucosamine hydrochloride, chondroitin sulfate, green lipped mussel, blue lipped mussel, methyl sulfonyl methane (MSM), boron, boric acid, phytoestrogens, phytoandrogens, genistein, diadzein, Lcarnitine, chromium picolinate, chromium tripicolinate, chromium nicotinate, acid/base modifiers, potassium citrate, potassium chloride, calcium carbonate, calcium chloride, sodium bisulfate; eucalyptus, lavender, peppermint, plasticizers, colorants, flavorants, sweeteners, buffering agents, slip aids, carriers, pH adjusting agents, natural ingredients, stabilizers, biological additives such as enzymes (including proteases and lipases), chemical additives, coolants, chelants, denaturants, drug astringents, emulsifiers, external analgesics, fragrance compounds, humectants, opacifying agents (such as zinc oxide and titanium dioxide), antifoaming agents (such as silicone), preservatives (such as butylated hydroxytoluene (BHT) and butylated hydroxyanisole (BHA), propyl gallate, benzalkonium chloride, EDTA, benzyl alcohol, potassium sorbate, parabens and mixtures thereof), reducing agents, solvents, hydrotropes, solubilizing agents, suspending agents (non-surfactant), solvents, viscosity increasing agents (aqueous and non-aqueous), sequestrants, keratolytics, egg shell membrane, ancient grain, and a combination of two or more thereof.

The pet food composition may be produced by various methods to achieve the desired pet food composition or desired form for the pet food composition. For example, dry food may be baked or extruded, then cut into individual shaped portions, such as kibbles. In some embodiments, the pet food composition may be prepared in a canned or wet form using conventional food preparation processes known to those of ordinary skill in the art. Typically, ground animal proteinaceous tissues are mixed with the other ingredients, such as cereal grains, suitable carbohydrate sources, fats, oils, and balancing ingredients, including special purpose additives such as vitamin and mineral mixtures, inorganic salts, cellulose, beet pulp and the like, and water in an amount sufficient for processing. The ingredients are mixed in a vessel suitable for heating while blending the components. Heating the mixture is carried out using any suitable manner, for example, direct steam injection or using a vessel fitted with a heat exchanger. Following addition of all of the ingredients of the formulation, the mixture may be heated to a temperature of from 50° F. to 212° F. Although temperatures outside this range can be used, they may be commercially-impractical without the use of other processing aids. When heated to the appropriate temperature, the material will typically be in the form of thick liquid, which is dispensed into cans. A lid is applied and the container is hermetically sealed. The sealed can is then placed in convention equipment designed for sterilization of the contents. Sterilization is usually accomplished by heating to temperatures of greater than 230° C. for an appropriate time depending on the temperature used, the nature of the composition, and related factors. The pet food compositions and food products of the present disclosure can also be added to or combined with food compositions before, during, or after their preparation.

In some embodiments, the food products may be prepared in a dry form using convention processes known to those of ordinary skill in the art. Typically, dry ingredients, including dried animal protein, plant protein, grains and the like are ground and mixed together. Liquid or moist ingredients, including fats, oils water, animal protein, water, and the like are added combined with the dry materials. The specific formulation, order of addition, combination, and methods and equipment used to combine the various ingredients can be selected from those known in the art. For example, in certain embodiments, the resulting mixture is process into kibbles or similar dry pieces, which are formed using an extrusion process in which the mixture of dry and wet ingredients is subjected to mechanical work at high pressure and temperature, forced through small openings or apertures, and cut off into the kibbles, e.g., with a rotating knife. The resulting kibble can be dried and optionally coated with one or more topical coatings comprising, e.g., flavors, fats, oils, powdered ingredients, and the like. Kibbles may also be prepared from dough by baking, rather than extrusion, in which the dough is placed into a mold before dry-heat processing.

In preparing a composition, any ingredient generally may be incorporated into the composition during the processing of the formulation, e.g., during and/or after mixing of the other components of the composition. Distribution of these components into the composition can be accomplished by conventional means. In certain embodiments, ground animal and/or poultry proteinaceous tissues are mixed with other ingredients, including nutritional balancing agents, inorganic salts, and may further include cellulose, beet pulp, bulking agents and the like, along with sufficient water for processing.

In accordance with another aspect, provided is a method for alleviating canines suffering from chronic gastroenteritis, the method comprising feeding a canine a pet food composition disclosed herein. In certain embodiments, the method may reduce the fecal amino acids, which promote putrefaction by gut microbes, by about 10% or more, preferably by about 15% or more, preferably by about 20% or more, preferably by about 30% or more, preferably by about 40% or more. For example, the method may reduce one or more fecal amino acids selected from alanine, arginine, asparagine, aspartate, cysteine, glutamate, glutamine, glycine, histidine, isoleucine, leucine, lysine, methionine, phenylalanine, proline, serine, taurine, threonine, tryptophan, tyrosine, valine, and a combination of two or more thereof. Additionally or alternatively, the method may reduce one or more fecal microbe heme metabolite (see Table 9, below), fecal microbe saccharolysis (see Table 10), and/or fecal endocannabinoids (see Table 11).

The method may include providing and/or feeding the canine a pet food composition disclosed herein. In some instances, the method may include providing and/or feeding the canine the pet food compositions for 1 or more days, preferably 5 or more days, preferably 7 or more days, preferably 10 or more days, preferably 14 or more days, preferably 30 or more days, or preferably 42 or more days. The method may include feeding the pet one time a day, two times a day, three times a day, or in some embodiments four or more times a day.

### EXAMPLES

### Example 1

A non-limiting, exemplary pet food composition (Example Composition A) and a comparative pet food composition (Comparative Composition 1) were prepared in accordance with aspects of the invention. The formula of Example Composition A and Comparative Composition 1 are shown in Table 1, provided below. Notable differences between the formulation of Example Composition and A and Comparative Composition 1 include the sources of protein, starch, fat, and fiber. Table 2 provides a summary of the nutritional values of Example Composition A and Comparative Composition 1.

TABLE 1

| | Comp. 1 | Ex. A |
|---|---|---|
| Ingredient | (wt. %) | (wt. %) |
| Chicken Fat | 3.1 | 5 |
| Soybean oil | 2 | 1.2 |
| Pork meat protein isolate, Hydrolyzed | | 15.5 |
| Whey Protein, Glutamine-rich peptides, | | |
| and Gelatin | | |
| Eggs dried | 14 | 8 |
| Chicken Dried | 21 | 12 |
| Corn gluten meal | 4 | |
| Cellulose | 7.2 | 5 |
| Flax seed whole brown | 1 | 2 |
| Beet pulp, Citrus pulp, Oat fiber, | | 5.5 |
| Psyllium husks, and Pectin | | |
| Medium Chain Triglycerides (1:1 of | | 3.5 |
| caprylate:caprate), and Fish oil | | |
| (containing 75% omega-3 fatty acids | | |
| present in triglyceride form) | | |
| Glycine | | 0.1 |
| Betaine base anhydrous, | | 1 |
| trimethylglycine | | |
| 1-Carnitine, 10% | | 0.3 |
| Alpha Lipoic acid 5% | | 0.3 |
| L-Cysteine hydrochloride monohydrate | | 0.1 |
| Methionine, dl | | 0.1 |
| Potassium Alginate | | 0.5 |
| High Amylopectin Potato Starch, and | | 33 |
| Potato starch | | |
| Brewer's Rice | 15 | |
| Whole Yellow Corn | 24.9 | |

TABLE 2

| | | | | Absolute | Relative |
|---|---|---|---|---|---|
| Food Analyte | Comp. 1 | Ex. A | Units | Difference | Difference |
| Acid Detergent Fiber | 5.1 | 8 | % | 2.9 | 57% |
| Fiber Crude | 4.2 | 4.3 | % | 0.1 | 2% |
| Fiber Insoluble | 10 | 9.8 | % | −0.2 | −2% |
| Fiber Neutral Detergent | 7.7 | 9.2 | % | 1.5 | 19% |
| Fiber Soluble | 0.2 | 1 | % | 0.8 | 400% |
| Fiber Total Dietary | 10.2 | 10.8 | % | 0.6 | 6% |
| Crude Protein | 32 | 33.2 | % DMB | 1.2 | 4% |
| Crude Protein | 87 | 91 | g/1000 kcal | 4 | 5% |
| | | | ME | | |
| Tryptophan | 0.41 | 0.3 | % | −0.11 | −27% |
| Tyrosine | 0.97 | 0.62 | % | −0.35 | −36% |
| Phenylalanine | 1.37 | 1.04 | % | −0.33 | −24% |
| Proline | 1.7 | 2.08 | % | 0.38 | 22% |
| Glycine | 1.72 | 3.09 | % | 1.37 | 80% |
| Vitamin B1 Thiamin | 3.85 | 14 | mg/100 g | 10.15 | 264% |
| Vitamin B2 - Riboflavin | 1.08 | 1.43 | mg/100 g | 0.35 | 32% |
| Vitamin B3 - Niacin | 10.5 | 12.7 | mg/100 g | 2.2 | 21% |
| Vitamin B5 - Pantothenic | 2.83 | 4.31 | mg/100 g | 1.48 | 52% |
| Acid | | | | | |
| Vitamin B6 - Pyridoxine | 1 | 2 | mg/100 g | 1 | 100% |
| Vitamin B7 - Biotin | 0.06 | 0.1 | mg/100 g | 0.04 | 67% |
| Betaine | 96.6 | 9910 | mg/kg | 9813.4 | 10159% |
| Vitamin B12 - Cobalamin | 12.4 | 36.6 | μg/100 g | 24.2 | 195% |
| Vitamin B9 - Folic Acid | 0.139 | 0.311 | mg/100 g | 0.172 | 124% |

### Example 2

Example composition A was evaluated in comparison to Comparative Composition 1 by feeding both pet food compositions to a group of canines. Specifically, a group of 38 canines were selected, with 19 of the canines being healthy and 19 of the canines having or being suspected of having chronic gastroenteritis. Dogs were considered healthy when there was no evidence of chronic systemic disease from physical examination, complete blood count, serum biochemical analyses, urinalysis, or fecal examination for parasites; exclusion criteria were recorded instances of gastrointestinal upset (vomiting, diarrhea) or abnormally low appetite. Inclusion criteria for dogs with chronic enteritis/gastroenteritis were diagnosis following endoscopy and histopathologic analysis of excised tissues confirming plasmacytic/lymphocytic inflammation. In a few cases, the research veterinarian deemed that the endoscopic procedure was not in the best interest of the dog's health, and observation of chronic symptomology sufficed.

The canines were fed Comparative Composition 1 for 4 weeks as a pre-feed regimen. After the 4 week pre-feed regimen, the canines were pair matched by gender, reproductive status, approximate age, and weight and divided into two groups for two feed regimens. For the first feed regimen, the first group of canines was fed Example Composition A for 4 weeks, while the second group of canines was fed Comparative Composition 1 for 4 weeks. After the 4 weeks of the first feed regimen, the first group of canines was fed Comparative Composition 1 for 4 weeks and the second group of canines was fed Example Composition A for 4 weeks as part of the second feed regimen.

During this evaluation, all canines were pair-housed in spacious indoor rooms with natural light. The canines received behavioral enrichment by interacting with each other, as well as through playtime with caretakers, daily opportunities to run outside, and access to toys. The canines were fed twice daily based on their daily nutritional needs and had ad libitum access to water. Symptoms of dogs with chronic enteritis/gastroenteritis were managed with bismuth subsalicylate, prednisolone, cobalamin, omeprazole, and prednisone as needed to maintain their quality of life. Blood and stool samples were evaluated for each of the canines at the start of this evaluations, at the end of the pre-feed regimen, after the first feed regimen, and after the second feed regimen.

When fed the Example Composition A, both healthy canines and those suffering from chronic gastroenteritis exhibited a decreased level of gut microbial putrefaction of tryptophan (e.g., indoles) in both feces (see Table 3) and serum (see Table 4) when compared to the Comparative Composition 1. Another type of putrefactive metabolite of tryptophan are kynurenines, which may be pro-inflammatory. Kynurenines were decreased in the feces of healthy canines and those suffering from chronic gastroenteritis when fed Example Composition A as compared to Comparative Composition 1 (see Table 5).

TABLE 3

| Fecal Putrefactive | Log Fold Change | | p Health |
|---|---|---|---|
| Indole | (Ex. A/Comp. 1) | p Diff | Diff |
| 2-oxindole-3-acetate | −4.20 | 3.7E−17 | 0.80 |
| 3-formylindole | −0.62 | 5.1E−09 | 0.30 |
| 3-hydroxyindolin-2-one | −0.87 | 1.0E−06 | 0.20 |
| 3-indoleglyoxylic acid | −2.10 | 4.2E−14 | 0.71 |
| 3-indoxyl sulfate | −0.13 | 0.13 | 0.78 |
| 5-hydroxyindoleacetate | −0.66 | 0.01 | 0.60 |
| Indole | 0.24 | 0.34 | 1.00 |
| indole-3-carboxylate | −3.75 | 9.1E−16 | 0.80 |
| Indoleacetate | −2.20 | 3.6E−11 | 0.33 |
| indoleacetylglycine | −0.20 | 0.27 | 0.94 |
| Indoleacrylate | −0.98 | 4.0E−08 | 0.20 |
| Indolelactate | −1.78 | 2.6E−08 | 0.91 |
| Indolepropionate | −0.77 | 1.7E−04 | 0.47 |
| indolin-2-one | 2.17 | 1.0E−08 | 0.50 |
| Oxindolylalanine | 0.08 | 0.50 | 0.30 |

TABLE 4

| | Log Fold Change | | p Health |
|---|---|---|---|
| Serum Putrefactive Indole | (Ex. A/Comp. 1) | p Diff | Diff |
| 1H-indole-7-acetic acid | −0.01 | 0.92 | 0.92 |
| 2-oxindole-3-acetate | −1.35 | 5.1E−04 | 0.15 |
| 3-formylindole | −0.11 | 0.36 | 0.08 |
| 3-hydroxyindolin-2-one | −0.25 | 0.09 | 0.13 |
| sulfate | | | |
| 3-indoleglyoxylic acid | −0.18 | 0.17 | 0.19 |
| 3-indoxyl sulfate | −0.29 | 5.9E−05 | 0.82 |
| 5-hydroxyindole glucuronide | −0.06 | 0.57 | 0.16 |
| 5-hydroxyindole sulfate | −0.26 | 0.01 | 0.67 |
| 6-hydroxyindole sulfate | −0.31 | 3.9E−05 | 0.47 |
| 7-hydroxyindole sulfate | 0.14 | 0.09 | 0.39 |
| indoleacetate | −0.45 | 0.06 | 0.76 |
| indoleacetylalanine | −0.55 | 0.02 | 0.74 |
| indoleacetylglutamine | −0.51 | 0.01 | 0.91 |
| indoleacetylglycine | −0.56 | 2.2E−03 | 0.88 |
| indoleacrylate | −0.47 | 2.9E−04 | 0.37 |
| indolelactate | −0.51 | 9.9E−04 | 0.68 |
| indolepropionate | −0.61 | 3.0E−04 | 0.42 |
| indolin-2-one | −0.38 | 3.2E−04 | 0.65 |
| indoxyl glucuronide | 0.03 | 0.81 | 0.32 |
| methyl indole-3-acetate | −0.19 | 0.14 | 0.29 |

TABLE 5

| | Log Fold Change | | p Health |
|---|---|---|---|
| Fecal Kynurenines | (Ex. A/Comp. 1) | p Diff | Diff |
| 3-hydroxykynurenine | −0.34 | 0.14 | 0.84 |
| kynurenine | −0.54 | 1.0E−04 | 0.54 |
| N-acetylkynurenine (2) | −0.76 | 4.6E−03 | 0.94 |
| kynurenate | −2.11 | 2.1E−06 | 0.30 |
| N-formylanthranilic | −0.12 | 0.23 | 0.51 |
| acid | | | |
| anthranilate | −0.90 | 4.2E−07 | 0.85 |

In addition to tryptophan, the amino acids phenylalanine and tyrosine can be putrefied to phenolic uremic solutes through the putrefactive action of gut microbes. The canines that consumed Example Composition A exhibited a decrease in the phenolic putrefactive post-biotics in their feces (see Table 6) and serum (see Table 7) as compared to the canines consuming Comparative Composition 1.

TABLE 6

| | Log Fold | | |
|---|---|---|---|
| | Change | | p |
| | (Ex. A/ | | Health |
| Fecal Putrefactive Phenol | Comp. 1) | p Diff | Diff |
| 2,4,6-trihydroxybenzoate | 1.37 | 1.6E−07 | 0.09 |
| 2,6-dihydroxybenzoic acid | −2.39 | 1.9E−11 | 0.49 |
| 3,4-dihydroxybenzoate | −0.54 | 0.13 | 0.24 |
| 3-hydroxybenzoate | −0.07 | 0.41 | 0.90 |
| 4-hydroxybenzoate | −1.83 | 1.4E−07 | 0.95 |
| 4-methylbenzenesulfonate | 0.06 | 0.82 | 0.79 |
| benzoate | 0.49 | 1.1E−04 | 0.01 |
| catechol sulfate | −0.61 | 2.1E−03 | 0.37 |
| hydroquinone sulfate | −1.53 | 7.8E−05 | 0.45 |
| 2-(4-hydroxyphenyl)propionate | 0.06 | 0.87 | 0.29 |
| 3-(2-hydroxyphenyl)propionate | 0.86 | 5.5E−04 | 0.32 |
| 3-(3-hydroxyphenyl)propionate | 0.67 | 0.13 | 0.17 |
| 3-(3-hydroxyphenyl)propionate | 0.21 | 0.50 | 0.83 |
| sulfate | | | |
| 3-(4-hydroxyphenyl)lactate (HPLA) | −2.71 | 9.9E−11 | 0.68 |
| 3-(4-hydroxyphenyl)propionate | −0.30 | 0.10 | 0.69 |
| 3,5-dihydroxyphenylpropionate | −1.16 | 1.1E−03 | 0.39 |
| 3-phenylpropionate | 0.79 | 0.01 | 0.39 |
| (hydrocinnamate) | | | |
| 4-hydroxyphenylacetate | −1.42 | 4.5E−07 | 0.61 |
| 4-hydroxyphenylacetylglycine | −0.05 | 0.73 | 0.48 |
| 4-hydroxyphenylpyruvate | −1.16 | 1.4E−04 | 0.13 |
| phenol sulfate | −1.33 | 4.8E−04 | 0.30 |
| phenyllactate (PLA) | −2.41 | 2.2E−08 | 0.81 |
| phenylpropionylglycine | 0.84 | 8.3E−06 | 0.82 |
| phenylpyruvate | −1.83 | 8.2E−09 | 0.12 |
| vanillactate | −1.74 | 1.0E−05 | 0.21 |
| vanillate | −2.09 | 8.4E−06 | 0.67 |
| dihydroferulic acid sulfate | −1.00 | 3.6E−04 | 0.70 |
| ferulate | −1.31 | 1.3E−07 | 0.40 |
| feruloylputrescine | −1.50 | 8.2E−07 | 0.23 |
| dihydroferulate | −3.38 | 2.2E−09 | 0.29 |

TABLE 7

| | Log Fold | | |
|---|---|---|---|
| | Change | | p |
| | (Ex. A/ | | Health |
| Serum Putrefactive Phenol | Comp. 1) | p Diff | Diff |
| 1,2,3-benzenetriol sulfate (2) | −2.24 | 2.7E−06 | 0.15 |
| 2,6-dihydroxybenzoic acid | −1.95 | 1.2E−10 | 0.77 |
| 4-hydroxybenzoate | −0.50 | 0.01 | 0.83 |
| 4-methylbenzenesulfonate | 0.22 | 0.18 | 0.99 |
| benzoate | −0.13 | 0.43 | 0.69 |
| methyl-4-hydroxybenzoate sulfate | 0.31 | 4.6E−03 | 0.93 |
| propyl 4-hydroxybenzoate sulfate | −0.15 | 0.56 | 0.55 |
| 3-methoxycatechol sulfate (1) | −0.99 | 2.6E−03 | 0.25 |
| 3-methoxycatechol sulfate (2) | −2.55 | 6.6E−12 | 0.66 |
| 3-methyl catechol sulfate (1) | 0.80 | 0.02 | 0.89 |
| 4-acetylcatechol sulfate (1) | −0.31 | 0.06 | 0.39 |
| 4-ethylcatechol sulfate | −0.95 | 1.8E−03 | 0.34 |
| 4-hydroxycatechol sulfate | −0.13 | 0.17 | 0.17 |
| 4-methylcatechol sulfate | 0.14 | 0.67 | 0.49 |
| 4-vinylcatechol sulfate | −1.84 | 1.8E−09 | 0.58 |
| catechol sulfate | −0.82 | 3.8E−04 | 0.42 |
| 2-hydroxyphenylacetate | −0.51 | 6.6E−05 | 0.33 |
| 3-(3-hydroxyphenyl)propionate sulfate | −0.05 | 0.88 | 0.63 |
| 3-(3-hydroxyphenyl)propionate | −0.13 | 0.65 | 0.88 |
| 3-(4-hydroxyphenyl)lactate (HPLA) | −0.23 | 4.9E−05 | 0.73 |
| 3-(4-hydroxyphenyl)propionate | −0.40 | 0.08 | 0.09 |
| 3-hydroxy-3-phenylpropionate | −0.46 | 0.03 | 0.81 |
| 3-phenylpropionate (hydrocinnamate) | −0.14 | 0.52 | 0.78 |
| 4-acetylphenyl sulfate | −0.56 | 5.2E−04 | 0.80 |
| 4-ethylphenyl sulfate | −0.07 | 0.17 | 0.92 |
| 4-hydroxyphenylacetate | −0.51 | 0.10 | 0.33 |
| 4-hydroxyphenylacetylglutamine | −0.95 | 5.2E−04 | 0.56 |
| 4-hydroxyphenylacetylglycine | −0.81 | 2.1E−03 | 0.50 |
| 4-hydroxyphenylpyruvate | −0.30 | 0.02 | 0.59 |
| 4-methoxyphenol sulfate | −1.96 | 2.4E−14 | 0.50 |
| 4-vinylphenol sulfate | −0.67 | 1.8E−07 | 0.43 |
| phenol sulfate | −0.18 | 0.21 | 0.44 |
| phenyllactate (PLA) | −0.28 | 0.03 | 0.78 |
| phenylpropionylglycine | −0.22 | 0.09 | 0.51 |
| phenylpyruvate | 0.17 | 0.19 | 0.92 |

Additionally, despite Example Composition A containing 10,000% or more betaine than Comparative Composition 1, the amount of circulating serum trimethylamine oxide was not significantly different between dogs receiving Example Composition A and those receiving Comparative Composition 1 (p=0.9). Instead, trimethylamine oxide was decreased in the feces of the canines that consumed Example Composition A compared to those consuming Comparative Composition 1 (p<0.0001). This effect did not differ between the healthy canines or those suffering from chronic gastroenteritis (p=0.74). In view of Example Composition A containing 10,000% or more of betaine than Comparative Composition 1, the inventors were surprised that Example Composition A reduced trimethylamine oxide in the canines' feces because several quaternary amine nutrients (e.g., betaine, carnitine, choline and trimethyllysine) can be putrefied to trimethyl amine, which is oxidized by host intestinal and hepatic Flavin mono-oxygenases to trimethylamine oxide. It is commonly believed that trimethylamine oxide can be detrimental to the cardio-renal health of a canine.

Without being limited to any specific theory, Example Composition A decreased the putrefactive products of amino acid metabolism by reducing the amount of gut microbial proteolysis. Reduced proteolysis would make fewer amino acid substrates available for putrefaction by gut microbes. Table 8 shows that the feces from both healthy canines and those suffering from chronic gastroenteritis that consumed Example Composition A manifested reduced levels of individual amino acid products of microbial proteolysis.

TABLE 8

| Fecal | Log Fold Change | | p Health |
|---|---|---|---|
| Amino Acids | (Ex. A/Comp. 1) | p Diff | Diff |
| alanine | −1.09 | 8.4E−09 | 0.23 |
| arginine | −0.36 | 4.5E−02 | 0.37 |
| asparagine | −3.10 | 1.8E−08 | 0.59 |
| aspartate | −1.03 | 3.4E−05 | 0.25 |
| cysteine | 0.95 | 1.7E−14 | 0.37 |
| glutamate | −0.71 | 2.1E−04 | 0.70 |
| glutamine | −1.82 | 5.9E−09 | 0.28 |
| glycine | −0.10 | 0.49 | 0.47 |
| histidine | −1.98 | 2.4E−11 | 0.41 |
| isoleucine | −2.19 | 1.5E−11 | 0.19 |
| leucine | −2.05 | 3.3E−11 | 0.18 |
| lysine | −0.71 | 3.7E−06 | 0.38 |
| methionine | −1.43 | 2.0E−11 | 0.39 |
| phenylalanine | −2.00 | 3.5E−10 | 0.33 |
| proline | −0.57 | 4.6E−04 | 0.17 |
| serine | −1.72 | 1.7E−09 | 0.17 |
| taurine | −1.16 | 4.9E−03 | 0.38 |
| threonine | −1.42 | 6.7E−10 | 0.22 |
| tryptophan | −2.37 | 4.9E−13 | 0.79 |
| tyrosine | −2.08 | 2.5E−10 | 0.38 |
| valine | −2.04 | 2.0E−11 | 0.22 |

As indication that the inhibitory effect of Example Composition A on microbial putrefaction extended beyond protein substrates, the products of heme (pyrrole) putrefactive breakdown were also reduced in the feces of canines receiving Example Composition A as compared to those receiving Comparative Composition 1 (see Table 9). This effect was equal in both healthy canines and those suffering from chronic gastroenteritis.

TABLE 9

| | | | p |
|---|---|---|---|
| Fecal Microbe Heme | Log Fold Change | | Health |
| Metabolite | (Ex. A/Comp. 1) | p Diff | Diff |
| I-urobilinogen | −1.28 | 3.5E−03 | 0.85 |
| L-urobilin | 0.60 | 0.10 | 0.32 |
| D-urobilin | −0.50 | 0.07 | 0.84 |
| biliverdin | −0.67 | 0.01 | 0.55 |
| bilirubin | −0.91 | 0.01 | 0.66 |
| bilirubin (E,E)* | −0.97 | 2.1E−03 | 0.58 |
| bilirubin degradation product, | −0.45 | 0.06 | 0.50 |
| C16H18N2O5 (2) | | | |
| bilirubin degradation product, | −0.75 | 3.4E−03 | 0.65 |
| C17H18N2O4 (2) | | | |
| bilirubin degradation product, | −0.79 | 4.4E−03 | 0.43 |
| C17H18N2O4 (3) | | | |
| protoporphyrin IX | 0.86 | 2.3E−04 | 0.19 |

Not only did the Example Composition A decrease microbial proteolysis of protein to amino acids (see Table 8), it also decreased microbial saccharolysis of fiber to individual sugars (see Table 10). Moreover, not only did Example Composition A decrease putrefaction of individual amino acids by gut microbes (see Tables 3-7 and 9), Example Composition A also decreased fermentation of individual sugars to lactic acid (see Table 10). Thus, there was an effect of the Example Composition A to decrease a broad swath of gut microbial activity.

TABLE 10

| Fecal Microbe | Log Fold Change | | p Health |
|---|---|---|---|
| Saccharolysis | (Ex. A/Comp. 1) | p Diff | Diff |
| arabinose | 0.15 | 0.49 | 0.86 |
| erythrose | −1.82 | 1.9E−06 | 0.67 |
| fructose | −0.71 | 5.4E−03 | 0.70 |
| fucose | −1.52 | 3.5E−07 | 0.26 |
| glucose | −0.88 | 1.9E−07 | 0.16 |
| maltose | −1.08 | 9.7E−06 | 0.26 |
| mannose | −1.16 | 4.6E−07 | 0.66 |
| ribose | −0.69 | 4.7E−05 | 0.37 |
| ribulose/xylulose | −0.69 | 0.05 | 0.46 |
| sedoheptulose | 0.16 | 0.58 | 0.78 |
| xylose | −1.36 | 3.8E−05 | 0.59 |
| lactate | −1.71 | 1.5E−07 | 0.50 |

Finally, the feces of canines (both healthy canines and those suffering from chronic gastroenteritis) receiving Example Composition A showed reduced levels of most endocannabinoids (see Table 11), with effects across the entire spectrum of endocannabinoids including acyl-ethanolamides, taurines, and amino acid conjugates as compared to canines receiving Comparative Composition 1. The inventors expect that Example Composition A would reduce endocannabinoid activation and strengthen gut barrier of canines receiving such pet food composition.

TABLE 11

| | Log Fold | | |
|---|---|---|---|
| | Change | | p |
| | (Ex. A/ | | Health |
| Fecal Endocannabinoids | Comp. 1) | p Diff | Diff |
| arachidonoyl ethanolamide | −1.55 | 5.6E−10 | 0.82 |
| arachidoyl ethanolamide (20:0)* | −0.31 | 0.02 | 0.93 |
| behenoyl ethanolamide (22:0)* | −0.19 | 0.26 | 0.83 |
| dihomo-linolenoyl ethanolamide | −1.18 | 5.0E−08 | 0.73 |
| docosahexaenoyl ethanolamide | −0.94 | 7.6E−07 | 0.48 |
| erucoyl ethanolamide (22:1)* | −0.18 | 0.20 | 0.59 |
| lignoceroyl ethanolamide | −0.12 | 0.49 | 1.00 |
| (24:0)* | | | |
| linolenoyl ethanolamide | −1.10 | 5.5E−07 | 0.23 |
| linoleoyl ethanolamide | −1.91 | 3.3E−13 | 0.52 |
| margaroyl ethanolamide* | −1.04 | 2.4E−10 | 0.73 |
| nervonoyl ethanolamide (24:1)* | −0.10 | 0.60 | 0.67 |
| oleoyl ethanolamide | −1.51 | 1.8E−13 | 0.42 |
| palmitoleoyl ethanolamide* | −1.59 | 7.9E−12 | 0.23 |
| palmitoyl ethanolamide | −1.41 | 2.2E−12 | 0.49 |
| stearoyl ethanolamide | −0.70 | 3.0E−07 | 0.59 |
| palmitoylcholine | 0.11 | 0.56 | 0.44 |
| stearoylcholine* | −0.49 | 0.03 | 0.86 |
| hexanoyltaurine | −0.90 | 0.03 | 0.25 |
| N-arachidonoyltaurine | −1.67 | 2.2E−07 | 0.13 |
| N-linolenoyltaurine* | −0.67 | 5.0E−04 | 0.18 |
| N-linoleoyltaurine* | −2.42 | 3.4E−09 | 0.37 |
| N-oleoyltaurine | −1.54 | 1.5E−08 | 0.78 |
| N-palmitoleoyltaurine* | −0.74 | 7.8E−06 | 0.14 |
| N-palmitoyltaurine | −2.02 | 1.2E−09 | 0.87 |
| N-stearoyltaurine | −1.58 | 1.5E−07 | 0.83 |
| N-linoleoylglycine | −0.14 | 0.40 | 0.94 |
| N-oleoylglycine | 0.20 | 0.44 | 0.98 |
| N-palmitoylglycine | −0.21 | 0.31 | 0.57 |
| N-linoleoylserine* | −2.41 | 8.2E−11 | 0.60 |
| N-oleoylserine | −1.97 | 3.7E−11 | 0.67 |
| N-stearoylserine* | −1.29 | 3.1E−07 | 0.66 |
| 2-linoleoylglycerol (18:2) | −1.63 | 1.1E−06 | 0.86 |
| 2-oleoylglycerol (18:1) | −1.00 | 2.1E−04 | 0.72 |
| 2-palmitoleoylglycerol (16:1)* | −0.37 | 0.01 | 0.38 |
| 2-palmitoylglycerol (16:0) | −0.17 | 0.09 | 0.97 |

1-29. (canceled)

30. A pet food composition comprising:
a fat;
from about 15 to about 50 wt. % of protein comprising two or more amino acids, wherein the two or more amino acids comprise glycine and proline;
from about 3.5 to about 35 wt. % of a fiber, the fiber comprising:
(i) from about 3 to about 30 wt. % of insoluble fiber, and
(ii) from about 0.5 to about 5 wt. % of soluble fiber; and
optionally, a carbohydrate,
wherein all weight percentages are based on the total weight of the pet food composition on a dry matter basis.

31. The pet food composition according to claim 30, wherein the fiber comprises an acid detergent fiber and a neutral detergent fiber, wherein a total amount of the acid detergent fiber and the neutral detergent fiber is from about 6 to about 20 wt. %.

32. The pet food composition according to claim 31, wherein the pet food composition has a weight ratio of the acid detergent fiber to the neutral detergent fiber of from about 2:1 to about 1:2.

33. The pet food composition according to claim 30, wherein the pet food composition has a weight ratio of insoluble fiber to soluble fiber from about 20:1 to about 8:1.

34. The pet food composition according to claim 30, wherein the pet food composition contains at least one of:
about 5 wt. % or less of tryptophan,
about 5 wt. % or less of phenylalanine, or
about 5 wt. % or less of tyrosine.

35. The pet food composition according to claim 30 further comprising one or more B vitamins selected from thiamin, riboflavin, niacin, pantothenic acid, pyridoxine, biotin, folic acid, cobalamin and a combination of two or more thereof.

36. The pet food composition according to claim 35, wherein the one or more B vitamins comprises at least three B vitamins selected from the group consisting of thiamin, riboflavin, niacin, pantothenic acid, pyridoxine, biotin, folic acid, cobalamin, and a combination of two or more thereof.

37. The pet food composition according to claim 35, wherein the one or more B vitamins comprises at least one of:
thiamin in an amount of from about 8 to about 20 mg/100 g,
pyridoxine in an amount of from about 1 to about 4 mg/100 g,
cobalamin in an amount of from about 10 to about 40 ug/100 g, and
folic acid in an amount of from about 100 to about 400 ug/100 g.

38. The pet food composition according to claim 35, wherein the pet food composition has a weight ratio of folic acid to cobalamin of from about 1:1 to about 50:1.

39. The pet food composition of claim 35, wherein the pet food composition has a weight ratio of thiamin to pyridoxine of from about 1:1 to about 30:1.

40. The pet food composition according to claim 30, further comprising at least one triglyceride.

41. The pet food composition according to claim 40, wherein the at least one triglyceride comprises a medium chain triglyceride.

42. The pet food composition according to claim 41, wherein the medium chain triglyceride comprises an aliphatic carbon chain comprising from 6 to 10 carbons.

43. The pet food composition according to claim 42, wherein the aliphatic carbon chain is selected from a caprylate component, a caprate component, or a combination thereof.

44. The pet food composition according to claim 40, wherein the at least one triglyceride comprises an omega-3 fatty acid component.

45. The pet food composition according to claim 44, wherein the omega-3 fatty acid component is selected from linolenic acid, stearidonic acid, eicosatetraenoic acid, eicosapentaenoic acid, docosapentaenoic acid, docosahexaenoic acid, and a combination of two or more thereof.

46. The pet food composition according to 41, wherein the at least one medium chain triglyceride comprises three aliphatic carbon chains comprising an omega-3 fatty acid component is selected from linolenic acid, stearidonic acid, eicosatetraenoic acid, eicosapentaenoic acid, docosapentaenoic acid, docosahexaenoic acid, and a combination of two or more thereof.

47. The pet food composition according to claim 30, further comprising betaine in an amount of from 0.01 to about 5 wt. %.

48. A pet food composition comprising:
from about 8 to about 50 wt. % of a fat;
from about 15 to about 50 wt. % of a protein comprising two or more amino acids, wherein the two or more amino acids comprise glycine and proline;
from about 3.5 to about 35 wt. % of a fiber, the fiber comprising:
(i) from about 3 to about 30 wt. % of insoluble fiber, and
(ii) from about 0.5 to about 5 wt. % of soluble fiber;
optionally, a carbohydrate in an amount up to 65 wt. %;
two or more triglycerides; and
two or more B Vitamins,
wherein all weight percentages are based on the total weight of the pet food composition on a dry matter basis.

49. A method for alleviating canines suffering from chronic gastroenteritis, the method comprising: feeding a canine a pet food composition according to claim 48.
